(19) United States
(12) Patent Application Publication
(10) Pub. No.: US 2005/0263277 A1
(43) Pub. Date: Dec. 1, 2005

(54) HVAC system controlled by a left-and-right independent process for use in an automobile

(76) Inventor: Man Hee Kim, Seoul (KR)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/116,872

(22) Filed: Apr. 28, 2005

(30) Foreign Application Priority Data
Apr. 28, 2004 (KR) 20040029527

(51) Int. Cl. B60H 3/00; B61D 27/00; B60H 1/00

(52) U.S. Cl. 165/203; 165/202; 165/42

(57) ABSTRACT

The present invention relates to a left and right independent control type air conditioner apparatus for a vehicle capable of achieving not only a temperature control and a left and right independent control in the direction of the air blowing during a cooling and heating operation in a vehicle indoor, but also a left and right independent control in an air blowing amount adjustment. An improvement is provided wherein an air blowing amount adjusting door is mounted in an air conditioning casing between an air blower and an evaporator for movement between multiple states to thereby distribute the air blowing amount supplied to a left air path and a right air path.

### FIELD OF THE INVENTION

The present invention applies to the technology of a HVAC system, and more precisely—to a HVAC system for use in automobiles, the systems being controlled by a left-and-right independent process for left-and-right cooling and heating of an automobile interior.

### BACKGROUND OF THE INVENTION

In the existing automobiles, HVAC systems (Heating, Ventilating & Air Conditioning System) for such air conditioning as cooling and heating of an automobile interior have become common, however lately, a more efficient air conditioning is being sought after for luxury automobiles, such as an HVAC system controlled by a left-and-right independent process providing for independent operation on the side of the driver's seat and on the side of the passenger's seat.

A basic example of such an air conditioning system controlled by a left-and-right independent process is presented on the attached FIG. 1. As presented in the Figure, the air flow path forming a HVAC casing (100) contains an evaporator (110), a heater (120) and an air blower (130), with an air intake casing (200) containing an air intake door (210) for providing air intake from both the automobile's interior and exterior towards the front of the air blower (130). Moreover, the air flow path directed from the evaporator (110) installed inside the HVAC casing (100) towards the interior of an automobile is divided by a partition (140); a pair of temperature adjustment doors (151,152) responsible for the right and the left side, respectively, are installed between the evaporator (110) and the heater (120), while air blowing direction adjusting doors (161,162,163, 164,165,166) etc. are installed at the rear for adjusting the direction at both the right and the left side of an automobile's interior. In accordance with the above, when either internal or external air, upon a turn of an air intake door (210), enters the HVAC casing (100) through the air blower (130) after passing through the evaporator (110) and the heater (120), depending on reorganization of the temperature adjustment doors (151,152) and the air blowing direction adjusting doors (161,162,163, 164,165,166), either internal or external air is distributed in an automobile's interior with regard to its left and right side, thus a choice of either hot or cold air blow can be obtained. However, in such an air conditioning system controlled by a left-and-right independent process, only the temperature adjustment and air blow direction in the left and right sides of an automobile's interior can be controlled independently, independent air blowing amount control is not possible, which is a problem. A design was presented to solve this issue by installing two separate air blowers in order to achieve independent control of air blowing amount, but in this case the cost and the design made this solution undesirable.

Moreover, there is a Korean unexamined patent No 2000-41725 (title: “Left and right independent control method for HVAC for the use in an automobile”), wherein a temperature adjustment door is installed between condenser and heater, with a mode door installed at the rear of the heater core, and thus the temperature adjustment and air blowing direction adjustment are made possible, and a technology of enabling the adjustment of air blowing amount was introduced by adding an air blowing distribution door between the condenser and temperature adjustment door. However, in the mentioned patent, the installation of an air blowing amount distribution door in the rear of the heat exchanger i.e. condenser, required designating a special space for the air blowing amount distribution door, thus the problem of working within design space constraint occurs.

### SUMMARY OF THE INVENTION

The present invention was developed in order to solve the above-mentioned former problems. One goal is to provide a HVAC system controlled by a left-and-right independent process for use in an automobile, the system being capable not only of independent left-and-right control of the temperature adjustment and the air blowing direction adjustment during cooling or heating operation of an automobile's interior, but also capable of left-and-right air blowing amount adjustment control, preferably within design space constraints.

According to one form of the present invention aimed at achieving the above-mentioned objective, in a left-and-right independent control type air conditioner apparatus for an automobile, in which an air flow path formed in the interior of an air conditioner casing having an air blower, an evaporator and a heater therein is divided into two parts, and wherein there are provided a temperature adjusting door and air blowing direction adjusting door capable of adjusting temperature and air blowing direction with respect to internal and external air supplied in the left and right directions in the automobile's interior through the air paths, there is an air blowing amount adjusting door installed between the said air blower and the said evaporator for thereby distributing the air blowing amount supplied to the said divided paths.

In accordance with one form of the invention, an improvement is provided in a left and right independent control type air conditioner apparatus for a vehicle in which an air flow path divided into two air paths is formed in the interior of an air conditioner casing having an air blower, an evaporator, and a heater therein. The apparatus is also provided with at least one temperature adjusting door and at least one air blowing direction adjusting door capable of adjusting temperature and air blowing direction, respectively, with respect to air supply to the left and right directions in a vehicle interior through the two air paths. The improvement includes an air blowing amount adjusting door mounted in the case between the air blower and the evaporator for selective movement between multiple states to thereby distribute the air blowing amount supplied to the two air paths.

The air blowing amount adjusting door can be designed either in a structure capable of adjusting an air blowing ratio in the divided air paths based on a rotation angle or in a film door structure having a plurality of air blowing adjusting through-holes.

Other objects, features, and advantages of the invention will become apparent from a review of the entire specification, including the appended claims and drawings.

### BRIEF DESCRIPTION OF THE DRAWINGS

FIG. 1 is a diagram of a prior art example of an air conditioner with left-and-right independent control;

FIG. 2 is a diagram of an embodiment of an air conditioner with left-and-right independent control according to the present invention;

FIG. 3 is a diagram of another embodiment of an air conditioner with left-and-right independent control according to the present invention;

FIG. 4a is a cross-sectional view of the air blowing amount adjustment door in the form of a film door, presented in FIG. 3, with identical amounts of left and right air blow; and

FIG. 4b is a cross-sectional view of the appearance of the air blowing amount adjustment door in the form of a film door, presented in FIG. 3, with different amounts of left and right air blow.

### DETAILED DESCRIPTION OF THE PREFERRED EMBODIMENT

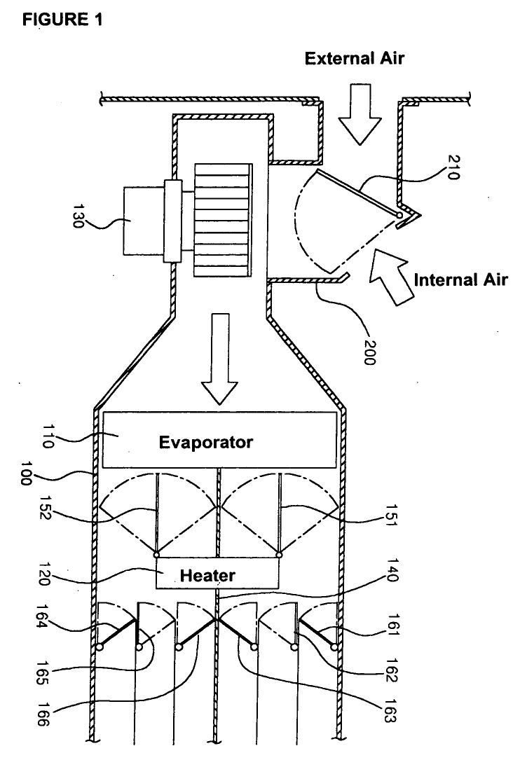

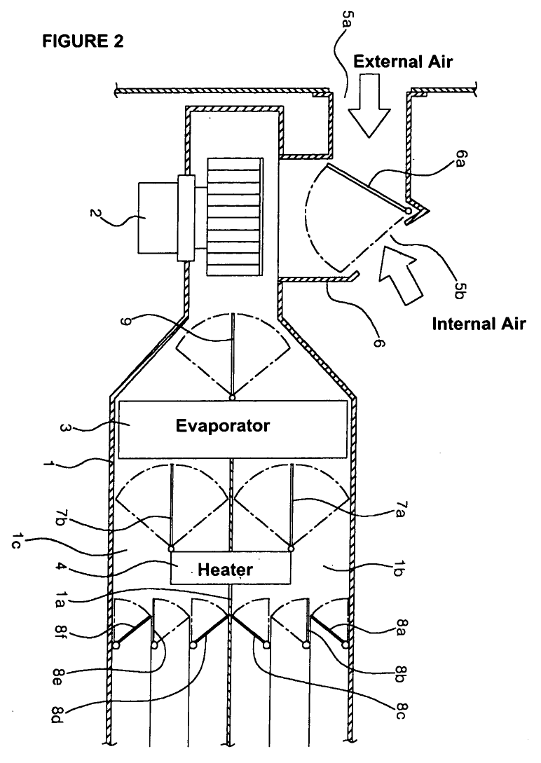

The attached FIG. 2 is a diagram of an embodiment of a left-and-right independent control type air conditioner according to the present invention. As seen in the illustration, the HVAC case (1) contains one air blower (2), one evaporator (3) and one heater (4). At the rear of the evaporator (3), inside the HVAC case (1), a first air flow path (1b) is divided from a second air flow path (1c) by a partition (1a). Moreover, an air intake casing (6) and an air intake door (6a) are installed to provide air intake from both the automobile's interior and exterior at the internal and external air intake (5a,5b) sides towards the front of the air blower (2). In addition, between the evaporator (3) and the heater (4), on the first air flow path (1b) and the second air flow path (1c) there are installed temperature adjusting doors (7a,7b) adjusting temperature of the automobile interior on the right and left sides respectively. At the rear of the heater (4), on the first air flow path (1b) and the second air flow path (1c), there are installed air blowing direction adjusting doors (8a,8b,8c,8d,8e,8f) etc. for adjusting the direction of the air blow in an automobile interior on the right and left sides respectively, according to the mode of the air conditioner (ventilation mode, defrost mode, blow mode etc.). An air blowing amount adjusting door (9) is installed between the air blower (2) and the evaporator (3). Preferably, an existing space is sufficient for installation of the air blowing amount adjusting door (9) inside the HVAC casing (1), and thus there is no need to create a special space for the door (9). This idea can be easily grasped by comparing to the former technology mentioned in reference to FIG. 1 or to the Korean unexamined patent No 2000-41725.

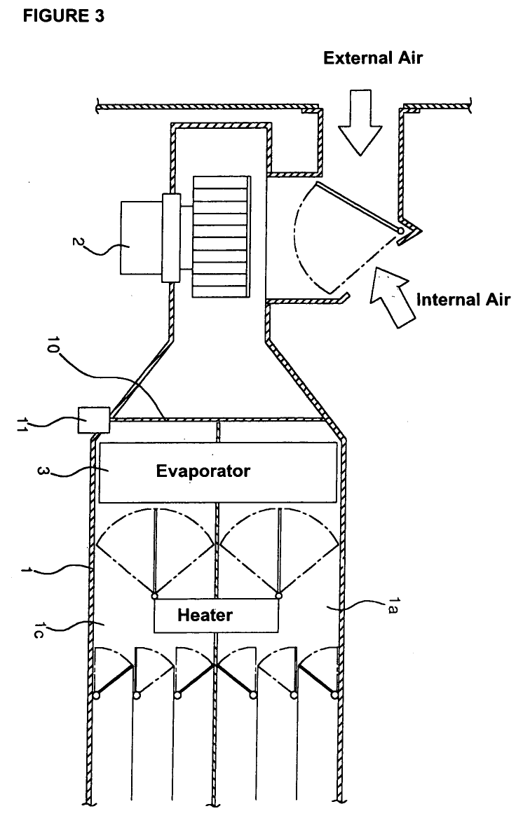

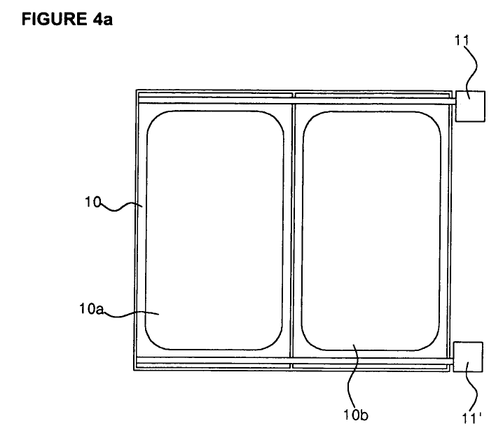

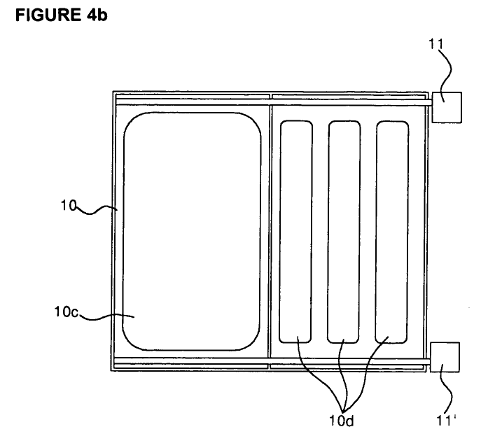

With reference to FIGS. 3-4b, another embodiment is shown wherein a plurality of through-holes (10a,10b,10c,10d) etc. for air blowing adjusting are formed in the air blowing adjusting door in the form of a thin plate film (10). Based on the operation of the motors (11,11′) closing or opening in one of the directions, the air blowing amount can be adjusted through the first air flow path (1b) and the second air flow path (1c). Particularly, as seen on FIG. 4a, if through-holes (10a,10b) of identical size are positioned in front of the first air flow path (1b) and the second air flow path (1c), the air blowing amount is identical in both the right and the left side of an automobile interior, while as seen on FIG. 4b, if through-holes (10c,10d) of different size are positioned in front of the first air flow path (1b) and the second air flow path (1c), the air blowing amount is different in the right and the left side of an automobile interior. Since the film door structure (10) of the air blowing amount adjusting door (10) occupies little space, this design is considered to be more advantageous.

As explained above, according to this invention, a left-and-right independent control type air conditioner apparatus for an automobile can accomplish not only an independent left-and-right control of the temperature adjustment and the air blowing direction adjustment during cooling or heating operation of an automobile's interior, but also left-and-right air blowing amount adjustment control, which provides more effective cooling or heating operation and thus enhances the comfort of the automobile interior, this being the effect of the invention.

Moreover, in the present invention, the construction of the apparatus to comprise the air blowing amount adjustment can be achieved within design space constraints, thus the effect is advantageous with respect to the design and the cost.

1. In a left and right independent control type air conditioner apparatus for a vehicle in which an air flow path is divided into two air paths formed in the interior of an air conditioner casing having an air blower, an evaporator and a heater therein, and wherein there are provided at least one temperature adjusting door and at least one air blowing direction adjusting door capable of adjusting temperature and air blowing direction, respectively, with respect to air supplied in the left and right directions in a vehicle interior through the two air paths, the improvement comprising:
an air blowing amount adjusting door mounted in the casing between the air blower and the evaporator for selective movement between multiple states to thereby distribute the air blowing amount supplied to the two air paths.

2. The apparatus of claim 1, wherein said air blowing amount adjusting door is pivotably mounted to adjust an air blowing ratio in the two air paths based on a rotational angle of the air blowing amount adjusting door.

3. The apparatus of claim 1, wherein said air blowing amount adjusting door comprises a film door structure having a plurality of air blowing adjusting through holes.
